(19) United States
(12) Patent Application Publication
(10) Pub. No.: US 2025/0273041 A1
(43) Pub. Date: Aug. 28, 2025

(54) ELECTRONIC GAMING MACHINE POWER MANAGEMENT ARCHITECTURES

(71) Applicant: Aristocrat Technologies, Inc., Las Vegas, NV (US)

(72) Inventors: Rolland Steil, Las Vegas, NV (US); Eric Taylor, Las Vegas, NV (US); Shane Perrow, Kembla Heights (AU)

(21) Appl. No.: 19/060,153

(22) Filed: Feb. 21, 2025

Related U.S. Application Data
(60) Provisional application No. 63/559,068, filed on Feb. 28, 2024.

(51) Int. Cl. G07F 17/32

(52) U.S. Cl. CPC G07F 17/3227; G07F 17/323; G07F 17/3255

(57) ABSTRACT

Electronic gaming machines (EGMs) and centralized power management systems (CPMSs) for EGMs are disclosed that allow for the power-usage states of EGMs to be centrally managed. Additionally, EGMs that feature user-selectable power-usage states coupled with mechanisms for recognizing environmentally responsible power-usage selections by users of the EGMs are disclosed.

### RELATED APPLICATION(S)

This application claims benefit of priority under 35 U.S.C. § 119 (e) to U.S. Provisional Patent Application No. 63/559,068, filed Feb. 28, 2024, which is hereby incorporated herein by reference in its entirety and for all purposes.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

Discussed herein are various centralized power management systems and EGMs designed to work with such centralized power management systems (or, in some cases, to operate independently without resort to a centralized power management system). Such systems and EGMs may facilitate operating EGMs in more power-efficient ways, including in ways that encourage users that are offered the ability to change the power-usage state of an EGM to make environmentally responsible decisions.

In some implementations, a system may be provided that includes one or more processors, one or more memory devices, and one or more communications interfaces. The one or more memory devices may store computer-executable instructions which, when executed by the one or more processors, cause the one or more processors to cause information regarding a first power-level setting to be retrieved from one or more databases, cause a first power-level setting message based on the information regarding the first power-level setting to be generated, and cause the first power-level setting message to be sent to each electronic gaming machine in a first set of one or more electronic gaming machines via the one or more communications interfaces, wherein the first power-level setting message caused to be sent to each electronic gaming machine in the first set of one or more electronic gaming machines is configured so as to cause that electronic gaming machine to enter a first power-usage state based, at least in part, on the first power-level setting.

In some such implementations, the information regarding the first power-level setting may include schedule information, and the computer-executable instructions, when executed by the one or more processors, may further cause the one or more processors to cause the first power-level setting message to be sent to each electronic gaming machine in the first set of one or more electronic gaming machines at a time defined by the schedule information.

In some implementations, the information regarding the first power-level setting may include schedule information, the first power-level setting message may include schedule parameters based on the schedule information, and the first power-level setting message caused to be sent to each electronic gaming machine in the first set of one or more electronic gaming machines may be further configured so as to cause that electronic gaming machine to enter the first power-usage state at a time defined by the schedule parameters.

In some implementations, the information regarding the first power-level setting may include component information, the first power-level setting message may include component parameters based on the component information, and the first power-level setting message caused to be sent to each electronic gaming machine in the first set of one or more electronic gaming machines may be further configured so as to cause that electronic gaming machine to select one or more gaming machine components of that electronic gaming machine based on the component parameters and to cause the selected one or more gaming machine components to change power states in order to cause the electronic gaming machine to enter into the first power-usage state.

In some implementations, the one or more databases may store information regarding multiple power-level settings, the multiple power-level settings including the first power-level setting and a second power-level setting, and the one or more memory devices may further store computer-executable instructions which, when executed by the one or more processors, further cause the one or more processors to cause information regarding the second power-level setting to be retrieved from the one or more databases, cause a second power-level setting message based on the information regarding the second power-level setting to be generated, and cause the second power-level setting message to be sent to each electronic gaming machine in a second set of one or more electronic gaming machines via the one or more communications interfaces, wherein the second power-level setting message caused to be sent to each electronic gaming machine in the second set of one or more electronic gaming machines is configured so as to cause that electronic gaming machine to enter a second power-usage state based, at least in part, on the second power-level setting. In such an implementation, the first set of one or more electronic gaming machines and the second set of one or more electronic gaming machines may have at least one electronic gaming machine in common, and the first power usage state and the second power usage state may be different from one another.

In some implementations, the information regarding the first power-level setting may include user-selectivity information, the first power-level setting message may include user-selectivity parameters based on the user-selectivity information, and the first power-level setting message caused to be sent to each electronic gaming machine in the first set of one or more electronic gaming machines may be further configured so as to cause that electronic gaming machine to enter the first power-usage state in response to receiving a message indicative of a selection of the power-usage state associated with the first power-level setting by a first user of the electronic gaming machine.

In some implementations, the information regarding the first power-level setting may include user benefit information, and the one or more memory devices may further store computer-executable instructions which, when executed by the one or more processors, further cause the one or more processors to receive a first user selection message from one of the electronic gaming machines in the first set of electronic gaming machines indicating that that electronic gaming machine has entered the first power-usage state in response to receiving the message indicative of the selection of the power conservation state associated with the first power-level setting by the first user, and cause a first benefit to be provided to the first player responsive, at least in part, to receipt of the first user selection message.

In some such implementations, the first benefit may be a benefit that affects play of a game on the electronic gaming machine from which the first user selection message was received.

In some additional or alternative such implementations, the first benefit may be an amount of loyalty program points provided to a loyalty program account associated with the first user.

In some additional or alternative such implementations, the first benefit may be a graphical indicator that is displayed in association with information associated with a user account belonging to the first user.

In some additional or alternative such implementations, the graphical indicator may be a badge, avatar, or graphical effect.

In some implementations, an electronic gaming machine may be provided that includes a gaming machine cabinet; one or more peripheral devices; one or more processors; one or more memory devices; and one or more displays supported by the gaming machine cabinet. The one or more memory devices may store computer-executable instructions which, when executed by the one or more processors, cause the one or more processors to: obtain information regarding a first power-level setting, cause at least some of the one or more peripheral devices to enter a first power-usage state defined by the information regarding the first power-level setting, obtain information regarding a second power-level setting associated with a user of the electronic gaming machine, and cause at least some of the one or more peripheral devices to enter a second power-usage state defined by the information regarding the second power-level setting, wherein the electronic gaming machine uses a lower amount of power in the second power-usage state than in the first power-usage state.

In some implementations, the one or more memory devices may store further computer-executable instructions which, when executed by the one or more processors, further cause the one or more processors to: obtain information identifying the user of the electronic gaming machine, transmit a request to a remote device for the information regarding the second power-level setting associated with the user of the electronic gaming machine, the request including the information identifying the user of the electronic gaming machine, and obtain the information regarding the second power-level setting associated with the user of the electronic gaming machine by receiving a message from the remote device having the information regarding the second power-level setting associated with the user of the electronic gaming machine.

In some implementations, the electronic gaming machine may further include one or more imaging sensors and the one or more memory devices may store further computer-executable instructions which, when executed by the one or more processors, further cause the one or more processors to: cause the one or more imaging sensors to obtain image information regarding the user of the electronic gaming machine, and transmit the image information, or information extracted from the image information, to the remote device as the information identifying the user of the electronic gaming machine.

In some implementations, the one or more memory devices may store further computer-executable instructions which, when executed by the one or more processors, further cause the one or more processors to: obtain information from the user regarding a player tracking account associated with the user, and transmit information identifying the player tracking account of the user to the remote device as the information identifying the user of the electronic gaming machine.

In some implementations, the one or more memory devices may store further computer-executable instructions which, when executed by the one or more processors, further cause the one or more processors to: cause a graphical user interface to be provided on the one or more displays, the graphical user interface including one or more user-selectable controls for enabling selection of the second power-level setting by the user, and cause the at least some of the one or more peripheral devices to enter the second power-usage state defined by the information regarding the second power-level setting responsive to receipt of an input signal indicating that the one or more user-selectable controls for enabling the selection of the second power-level setting by the user was or were selected by the user.

In some implementations, the one or more memory devices may store further computer-executable instructions which, when executed by the one or more processors, further cause the one or more processors to cause a benefit to be provided to the user in response to the user causing the at least some of the one or more peripheral devices to be in the second power-usage state for at least a first period of time or for a first number of game plays.

In some such implementations, the benefit may affect play of a game presented on the one or more displays of the electronic gaming machine.

In some other such implementations, the benefit may be an amount of loyalty program points provided to a loyalty program account associated with the user.

In some implementations, the benefit may be a graphical indicator that is displayed in association with information associated with a user account belonging to the user.

In some implementations, the electronic gaming machine may further include a sensor, such as a proximity sensor, an imaging sensor, or a motion sensor. In such implementations, the one or more memory devices may store additional computer-executable instructions which, when executed by the one or more processors, further cause the one or more processors to enter a power-usage state in which the electronic gaming machine uses a lower amount of power than in the first power-usage state when data from the sensor suggests that there are no people within a first region proximate the electronic gaming machine, and enter the first power-usage state when the data from the sensor suggests that one or more people are within the first region proximate the electronic gaming machine.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 3 illustrates, in block diagram form, an implementation of a game processing architecture algorithm that implements a game processing pipeline for the play of a game in accordance with various implementations described herein.

FIG. 4 depicts an example of such a power-management setting technique.

FIG. 5 depicts an example implementation of a schedule-based power-management setting technique.

FIG. 6 depicts an example implementation of another schedule-based power-management setting technique.

FIG. 7 depicts an example technique for implementing user-selectable power-usage settings for an EGM.

FIG. 8 depicts an example technique for implementing component-level power-usage settings for an EGM.

### DETAILED DESCRIPTION

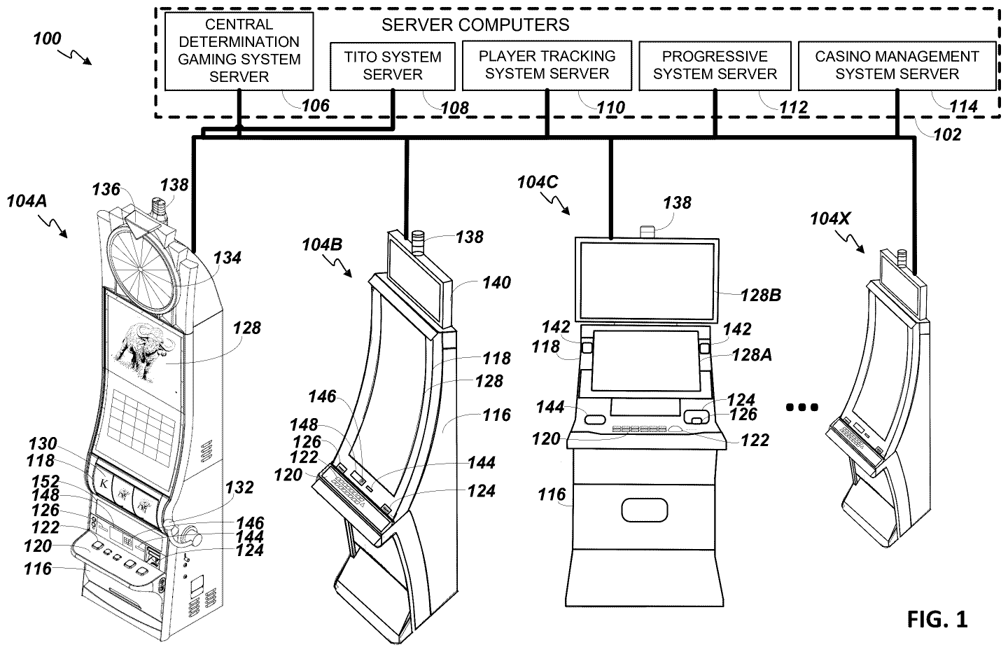

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. The server computers may also include a centralized power management system (CPMS), as described later below. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

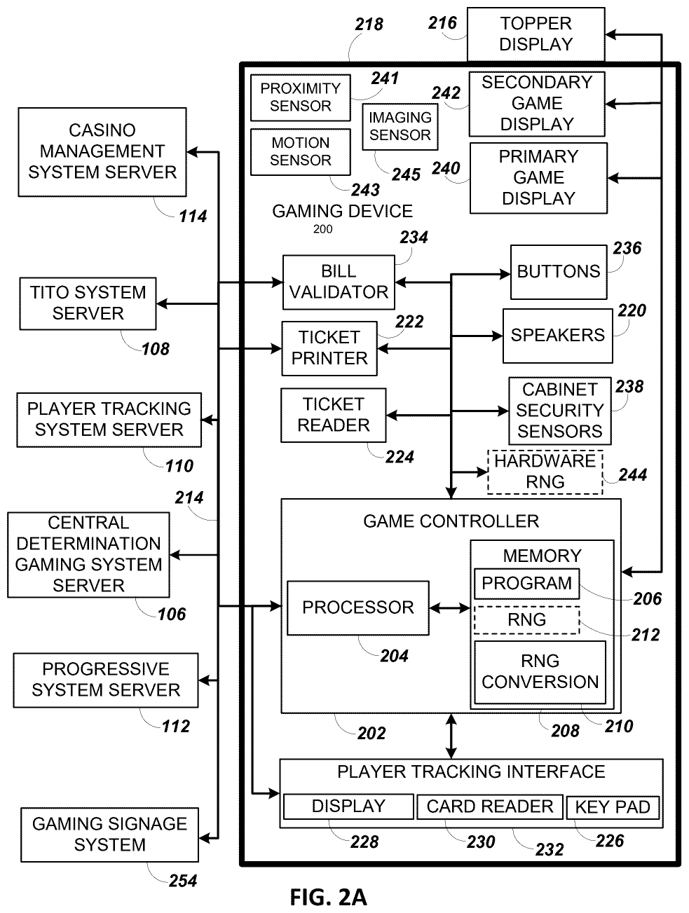

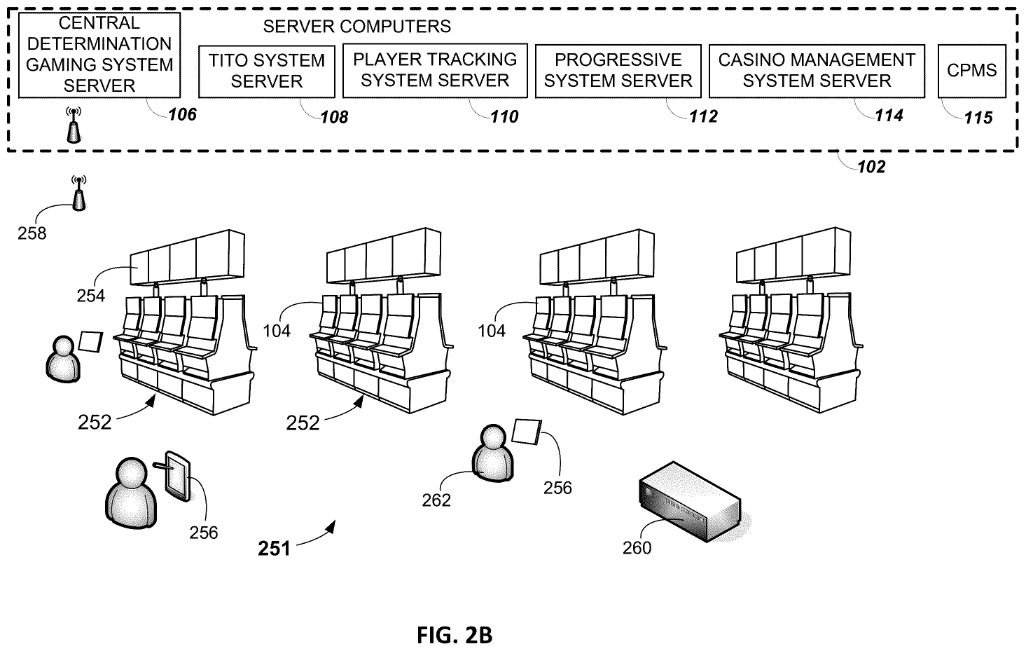

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile devices 256, which are also configured to present wagering games in this example. The mobile devices 256 may, for example, include tablet devices, cellular phones, smart phones and/or other handheld devices. In this example, the mobile devices 256 are configured for communication with one or more other devices in the casino 251, including but not limited to one or more of the server computers 102, via wireless access points 258.

In some implementations, the casino 251 may include one or more kiosks 260 that are configured to facilitate monetary transactions involving the mobile devices 256, which may include cash out and/or cash in transactions involving a wallet managed via the mobile device. The kiosks 260 may be configured for wired and/or wireless communication with the mobile devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile device 256 for wagering purposes, e.g., via a wireless link such as a near-field communications link. In some such examples, when a casino patron 262 is ready to cash out, the casino patron 262 may select a cash out option provided by a mobile device 256, which may include a real button or a virtual button (e.g., a button provided via a graphical user interface) in some instances. In some such examples, the mobile device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile device 256 and/or a kiosk 260.

Some mobile devices 256 may be configured for receiving and/or transmitting player loyalty information. For example, some mobile devices 256 may be configured for wireless communication with the player tracking system server 110. Some mobile devices 256 may be configured for receiving and/or transmitting player loyalty information via wireless communication with a patron's player loyalty card, a patron's smartphone, etc.

According to some implementations, a mobile device 256 may be configured to provide safeguards that prevent the mobile device 256 from being used by an unauthorized person. For example, some mobile devices 256 may include one or more biometric sensors and may be configured to receive input via the biometric sensor(s) to verify the identity of an authorized patron. Some mobile devices 256 may be configured to provide certain functions only within a predetermined or configurable area, such as a casino gaming area.

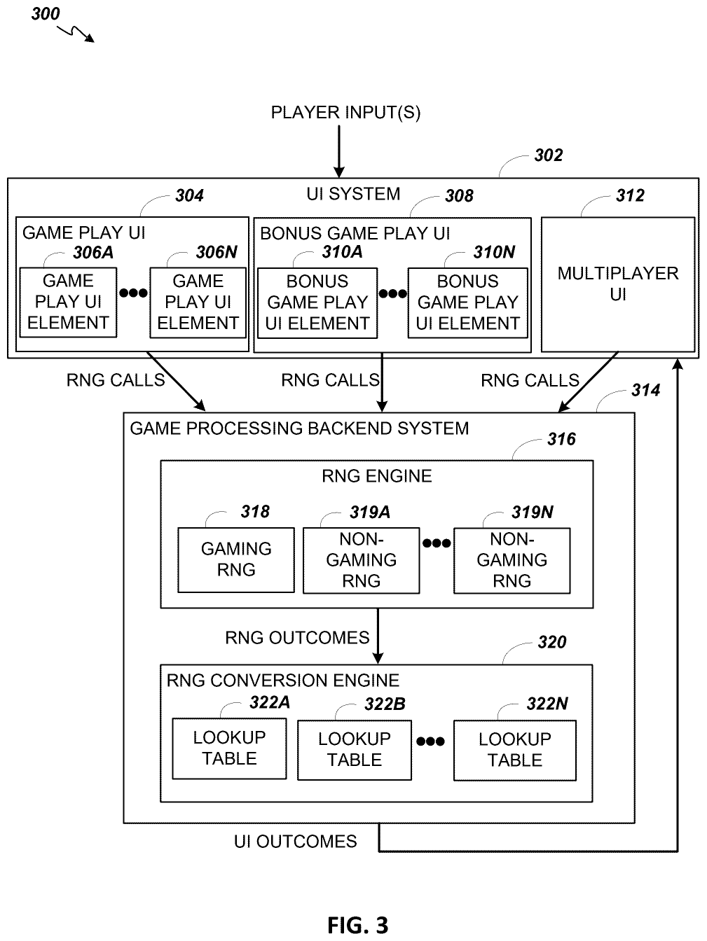

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Modern electronic gaming machines may include a variety of electronic devices that may, in aggregate, consume large amounts of electrical power. For example, it is not uncommon for such electronic gaming machines to include one, and possibly multiple high-resolution monitors or displays, a variety of LED lighting systems that provide lighting effects in various locations on the exterior of the EGM, speaker systems, and one or more processing units, including one or more central processing units (CPUs) and potentially one or more graphics processing units (GPUs). When coupled with the fact that such EGMs are typically in service twenty-four hours a day and seven days a week for extended periods of time, the ongoing power needs of such EGMs, when coupled with the large numbers of such EGMs that may be present in a given casino, represent a significant amount of power consumption. For example, larger casinos may field on the order of 2000 to 3000 EGMs, with each EGM drawing on the order of 100 to 200 watts, although some premium EGMs may have power consumption that is much higher, e.g., on the order of 500 watts or 600 watts or higher. If a casino has, for example 2500 EGMs that each draw, on average, 150 watts of power, the daily power consumption of such a fleet of EGMs may be on the order of 9,000 kWh and may cost hundreds of thousands of dollars per year.

The present disclosure is directed to systems for intelligently managing the power consumption of EGMs with the assistance of a centralized power management system. Such a system may include, or have access to, a database of information regarding different power-level settings and associated information. Such associated information may include, for example, scheduling information, EGM selection information, user selectivity information, component information, etc.-information that may be used by the system to then configure EGMs (and potentially other equipment, such as signage) to enter particular power-usage states. It will be understood that the EGMs that this disclosure is directed at are cabinet-type EGMs, e.g., that are designed to be stationary pieces of equipment (potentially arranged in banks or clusters) on a casino floor or integrated into other stationary equipment, such as a tabletop or bartop.

The system, which may be referred to as a centralized power management system (CPMS), may be designed to operate in concert with EGMs that are configured to receive messages from the CPMS and to then adjust their level of power consumption responsive, at least in part, to the receipt of such messages. The CPMS may provide for centralized management of power-level settings that may then be used to generate power-level setting messages that are distributed to a large number of EGMs distributed throughout a particular casino or property, or across multiple casinos or properties. Such power-level setting messages may be configured to cause the EGMs receiving them to reconfigure themselves so as to use more or less power, thereby allowing for the rapid configuration of power usage settings for large numbers of EGMs in a flexible and efficient manner.

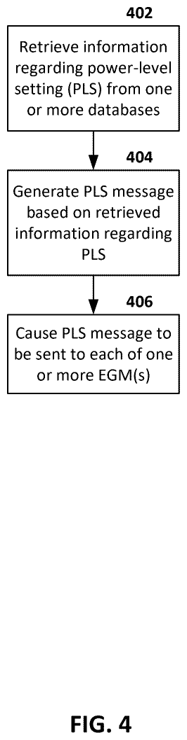

FIG. 4 depicts an example of such a power-management setting technique. In block 402, the CPMS may retrieve, from one or more databases, information regarding a power-level setting. In block 404, a power-level setting message may be caused to be generated, e.g., by the CPMS. The power-level setting message may be generated based on the information retrieved from the one or more databases and may be configured such that an EGM that receives the power-level setting message when it is sent there, e.g., in block 406, may configure itself to enter a power-usage state defined by the power-level setting at least partially in response to the receipt of the power-level setting message.

As noted above, the EGMs that may cooperate with the CPMS may be configured to receive messages from the CPMS and then adjust their power usage states based, at least in part, on information in such messages. Thus, such EGMs may have the ability to enable or disable certain components or subsystems, adjust the amount of power consumed by certain components or subsystems, or otherwise tailor or adjust the aggregate amount of power consumed by the components and subsystems of the EGM so as to place the EGM into a particular power-usage state. Such EGMs may, for example, be switchable between at least two different power-usage states including a first power-usage state and a second power-usage state. Such an EGM may, in the first power-usage state, use less electrical power than when in the second power-usage state. Such EGMs may, in some cases, also be switchable into additional power-usage states.

In some instances, such an EGM may be pre-configured with different power-management profiles that are each associated with a different power-usage state of the EGM. Each such power-management profile may include parameters that may define a set of predefined power-usage settings, power states, etc. for various components or subsystems of the EGM. At least some such power-management profiles for a given EGM may, when the EGM adjusts the power settings, power states, or other aspects of components or subsystems of the EGM for the various components or subsystems according to such power-management profiles, cause the overall power-usage state of the EGM to change such that the EGM uses a different amount of power when in each such power-usage state.

For example, an EGM may have three power-management profiles: a default power-management profile, a low power-conservation power management profile, and a high power-conservation power management profile. The default power management profile may include power-usage settings that, when implemented by the EGM, cause the various components and subsystems of the EGM to operate in their default, e.g., full-power, power states. The low power-conservation power management profile may include power-usage settings that, when implemented by the EGM, cause, for example, the external lighting components of the EGM to operate at 50% of the brightness used in the default power management profile, the resolution of the main display of the EGM to transition from a 4K resolution used in the default power management profile to a 1080p resolution, and the clock speed of the CPU and the GPU of the EGM to be reduced to 80% of the clock speed used by those components in the default power management profile. The high power-conservation power management profile may include power-usage settings that, when implemented by the EGM, cause, for example, the brightness of the external lighting components of the EGM to be reduced to 10% of the intensity that such components are operated in according to the default power management profile, the resolution of the main display of the EGM to transition from a 4K resolution to a 1080p resolution, and the CPU and the GPU of the EGM to placed into a sleep state, e.g., equivalent to an S1 sleep state in a Windows™ desktop computer.

The CPMS may, for such an EGM, send a message to the EGM that identifies which power-management profile the EGM is to use in order to cause the EGM to operate in a desired power-usage state. Such designations may, for example, include a code that identifies a particular power-usage state on each EGM-for example, a code of 0 may indicate a default power-usage state in which the EGM operates at a maximum average level of power consumption, while a code of 1 may indicate a minimal power-usage state in which the EGM is in standby mode with no lights active and no graphics displayed on the displays and a code of 2 may indicate a power-usage state in which the EGM is still active, e.g., displaying graphics on the displays and causing lighting devices associated with the EGM to emit light, but operating at a reduced level of energy consumption as in the power-usage state associated with the 0 code, e.g., at 50% of the average power consumption rate that the EGM has when in the power usage-state associated with the 0 code. At the same time, another EGM may have power management profiles that are associated with similar codes, but where one or more such codes may represent other power-usage states than in the EGM discussed above. For example, codes 1 and 2 may both represent power-usage states in which the EGM displays graphics on the displays (the EGM is thus not in a standby mode); such power-usage states may still be different in terms of power consumed, however. Thus, a power-level setting message that is sent to multiple EGMs and that designates that the recipient EGMs are to enter a power-usage state associated with a power management profile “1,” for example, may result in such EGMs operating in different power-usage states, depending on how the power management profile “1” is configured for each EGM. However, in other implementations, power management profiles on different EGMs that are assigned to have the same codes may also be configured to produce similar levels of power usage by such EGMs when such EGMs are placed into the corresponding power-usage states defined by such power management profiles. It will also be understood that “similar levels of power usage” may refer to either absolute power usage, e.g., the average power draw of the EGM (such as 100W), or current average power usage of the EGM as a percentage of average maximum power usage of the EGM, e.g., 75% of average maximum power. In some contexts, “similar levels of power usage” may refer to levels of power usage that fall within a particular range of power usage, e.g., power usage levels that fall within ±10W, ±20W, or ±30W (or ±5%, ±10%, ±15%) of a specified power usage level may be considered to be of a “similar level” to the specified power usage level.

In some implementations, such power-management profiles may each be associated with a corresponding numeric value. Such numeric values may, in some instances, correspond to the amount of power used by the EGM, as a percentage of the maximum amount of power that the EGM may use, when configured according to the corresponding power-management profiles. In other instances, such numeric values may simply be ordinal indicators, e.g., 1, 2, 3, 4, etc. that are each associated with a particular power-management profile. Such values, however, may be selected so as to increase (or, alternatively, decrease) in step with the increasing power-usage states of the power-management profiles, such that as the EGM institutes the power-management profiles in the sequence specified by the ordinal indicators, each successive power-usage state that the EGM progresses through will cause the EGM to consume less (or more, depending on the direction in which the EGM progresses through the power-management profiles) power.

For EGMs that associate some type of numeric value with each power-management profile, as discussed above, it may be advantageous to adopt a common numeric framework that is used for all of the EGMs managed by the CPMS. For example, if each power-management profile for each EGM is assigned a numeric value that corresponds to the amount of power used by that EGM when operating according to that power-management profile as a percentage of the power used by that EGM when in its maximum power-usage state, then such EGMs may all, in effect, adjust power-usage in a similar manner in response to receiving messages designed to cause the EGMs to enter a particular power-usage state.

Associating power-management profiles of EGMs with numeric values may also allow for more flexible approaches to power management. For example, such EGMs may be configured to attempt to select a power-management profile that has a numeric value that corresponds with, for example, a numeric value included in a message from the CPMS indicating a desired power-usage state. However, if the EGM does not have a power-management profile that is associated with a matching numeric value, the EGM may, in some cases, be configured to select a power-management profile that is associated with a numeric indicator that is closest in value to, but higher than, the numeric value included in the message or, alternately, closest in value to, but lower than, the numeric value included in the message. Such an approach allows such EGMs to flexibly adapt to messages that include settings designed to cause the EGM to enter power-usage states that the EGM may not specifically be configured to operate in. In such instances, such EGMs may instead enter a different power-usage state that is “closest” to the desired power-usage state (although the EGM may take a “greedy” or “non-greedy” approach to selecting which power-usage state to enter into, e.g., an EGM that is designed to utilize a “greedy” approach may select a power-management profile that causes the EGM to operate in a power-usage state that is lower than and closest to the desired power-usage state, while an EGM that is designed to utilize a “non-greedy” approach may select a power-management profile that causes the EGM to operate in a power usage state that is higher than and closest to the desired power-usage state.

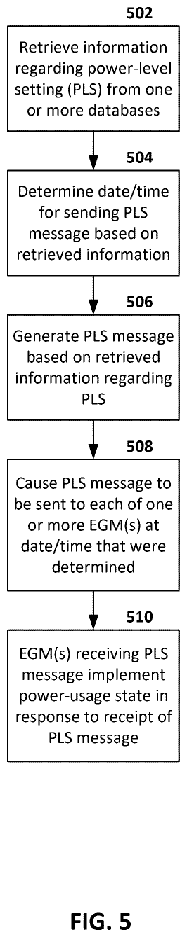

EGMs that are configured to change power-usage states based on power-level settings provided by the CPMS may be configured to enter such power usage states in response to various stimuli. For example, in some implementations, such an EGM may be configured to change its power-usage state in response to receiving a message, e.g., a power-level setting message, from the CPMS that includes information that is configured to cause the EGM to enter a particular power-usage state. In such implementations, the CPMS may, in conjunction with retrieving the power-level setting information from the one or more databases, also retrieve schedule-related information from the one or more databases that defines one or more dates and times at which one or more EGMs are to be caused to change their power-usage state in accord with the power-level setting. FIG. 5 depicts an example implementation of such a technique. In block 502, the CPMS may retrieve information regarding a power-level setting from one or more databases. The information may include information identifying one or more dates and times at which the relevant power-level setting is to be implemented on one or more EGMs. In block 504, the CPMS may determine at which dates and times to cause certain EGMs to implement a power-usage state defined by the power-level settings. In block 506, the CPMS may generate a power-level setting message that is configured to, on receipt of the power-level setting message by an EGM, cause the EGM to enter the power-usage state defined by the power-level settings. In block 508, the CPMS may cause the generated power-level setting message(s) to be sent to one or more EGMs, while in block 510, the EGMs that receive the power-level setting messages from block 508 may, in response to receipt of such power-level setting messages, reconfigure themselves in order to implement the power-usage state defined by the power-level setting.

In some other or additional such implementations, the EGM may be configured change power-usage state according to schedule parameters that may be included in the power-level setting message, e.g., at a time or times after the time when the EGM actually received the power-level setting message. Thus, at least some such EGMs may, in effect, be able to change power-usage state on-demand, e.g., in response to receipt of a power-level setting message sent by the CPMS (e.g., in real-time), and/or on a pre-scheduled basis, e.g., responsive to a processor of the EGM determining that the current time and date match a pre-scheduled start time and date for enabling a particular power-usage state.

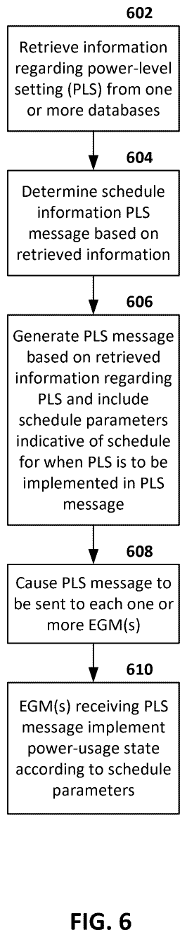

FIG. 6 depicts an example implementation of such a technique. In block 602, the CPMS may retrieve information regarding a power-level setting from one or more databases. The information may include information identifying one or more dates and times at which the relevant power-level setting is to be implemented on one or more EGMs. In block 604, the CPMS may determine at which dates and times to cause certain EGMs to implement a power-usage state defined by the power-level settings. In block 606, the CPMS may generate a power-level setting message that is configured to, on receipt of the power-level setting message by an EGM, cause the EGM to schedule implementing the power-usage state defined by the power-level settings according to various schedule parameters contained in the power-level setting message. In block 608, the CPMS may cause the generated power-level setting message(s) to be sent to one or more EGMs, while in block 610, the EGMs that receive the power-level setting messages from block 608 may, in response to receipt of such power-level setting messages, monitor the time and date and then implement the power-usage state defined by the power-level setting in accordance with the date and time reflected in the information retrieved from the one or more databases in association with the retrieved power-level setting.

In yet other or further implementations, such EGMs may be configured to change their power-usage states in response to a particular event, such as a user selection of a particular control presented on a graphical user interface (GUI) of the EGM. For example, some EGMs may be configured to present a GUI, e.g., in an interface that allows players to adjust various operating parameters of the EGM (such as music volume and/or sound effect volume), a user-selectable or adjustable control that allows the user to select between at least two (and possibly more) different power-usage states that the EGM may be placed in by the user. Such a control may, for example, take the form of a toggle button (for example, if there are only two user-selectable power-usage states available, the choice may be binary and a simple toggle button may be sufficient to allow the user to choose one or the other power-usage state), an option group of radio buttons, toggle buttons, or checkboxes (if more than two user-selectable power-usage states are available for the user to select between), or a slider or dial control that the user can move between different positions, with each position corresponding to a different one of the available power-usage states (and arranged such that as the slider or dial control is moved from its minimum position to its maximum position, the power-usage states corresponding to the positions that the slider or dial control is moved through are associated with lower and lower power-usage states). Regardless of the particular mechanism used to provide the user with the ability to select an available power-usage state, the selection by the user may cause a message indicative of a selection of a particular power-usage state by the user to be transmitted, generated, or otherwise received by one or more processors of the EGM, thereby causing the EGM to react accordingly and reconfigure itself, if need be, to the user's selection.

To facilitate such user-selectivity of power-usage settings, power-level setting messages sent by the CPMS may, for example, include user-selectivity parameters that may identify when the power-usage state defined by a certain power-level setting message is to be treated by the receiving EGM as being a user-selectable power-usage state. In many instances, there may only be two user-selectable power-usage states defined by the user-selectivity parameters sent via power-level setting messages to a particular EGM, but in other implementations, there may be more, e.g., three, four, etc.

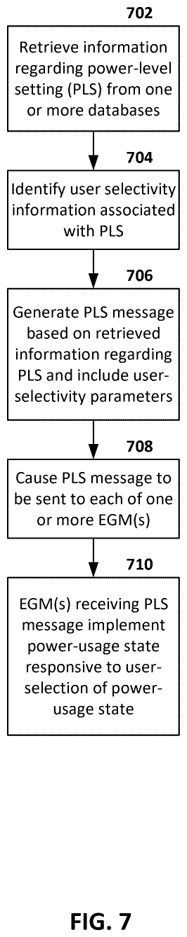

FIG. 7 depicts an example technique for implementing user-selectable power-usage settings for an EGM. In block 702, the CPMS may retrieve information regarding a power-level setting from one or more databases. In block 704, the CPMS may determine whether the information includes user-selectivity information identifying whether or not the relevant power-level setting is to be implemented on one or more EGMs as a user-selectable power-usage setting. In block 706, the CPMS may generate a power-level setting message that includes user-selectivity parameters that may, on receipt of the power-level setting message by an EGM, cause the EGM to configure itself to offer the power-usage state defined by the power-level settings as a user-selectable power-usage state, e.g., via a GUI. In block 708, the CPMS may cause the generated power-level setting message(s) to be sent to the one or more EGMs, while in block 710, the EGMs that receive the power-level setting messages from block 708 may, in response to receipt of such power-level setting messages, configure themselves to offer a GUI that includes one or more user-selectable controls that allow a user to selectively enable the power-usage state defined by the power-level setting message.

In some implementations, EGMs that incorporate the ability for a user to modify the power-usage state may do so in a manner that allows a user to pre-specify their preferred power-usage states and for the EGM to then automatically change power-usage states based on such preferences. For example, a user may be associated with an account, such as a player tracking account, that may contain information specific to that user, such as their name, address, awards or benefits that that user has been provided with, their play history on EGMs, etc. Such an account may also, in some instances, be configured to store information regarding the user's preferences of how they prefer the power-usage state be managed on EGMs that they use. Such information may, for example, be provided by the user via a settings or preferences interface for the player tracking account, e.g., via a web portal that allows the user to review and change various parameters associated with their player tracking account.

When a user having a player tracking account first starts interacting with a particular EGM, the user will typically provide the EGM with some form of identification, e.g., presenting a player tracking card, logging in with a username and password, or presenting a device associated with the user, e.g., a smartphone, that has a near-field-communications (NFC) or Bluetooth interface that can communicate with the EGM in order to identify the user to the EGM, that allows the EGM to determine that the user is associated with the player tracking account in question. The EGM may then send a request to a server, e.g., a player tracking server, that maintains information relevant to the player tracking account-including information regarding the user's power-usage state preferences-and obtain, in response to the request, information from that server that is relevant to that user. The EGM, responsive to receipt of the user's power-usage state preferences, may then automatically adjust its power-usage state to align with the user's power-usage state preferences. The EGM may make such power-usage state adjustments in a manner similar to how the EGM may make power-usage state adjustments based on a power-level settings message received from the CPMS, thereby allowing the user to specify a particular desired power-usage setting that may not have a direct corollary on certain EGMs-such EGMs may nonetheless modify their power-usage states to try and align their power-usage states with the user's preferences to the degree possible and according to any “greediness” settings that the EGM may operate with. In some implementations, the player tracking server and the CPMS may, in effect, be integrated into one overarching EGM management system or architecture, while in some other implementations, the CPMS may separately store user power-usage preferences in connection with information identifying the corresponding user, and the EGM may instead query the CPMS for such power-usage preferences.

In some implementations, EGMs that incorporate power-management systems that reference user-specified power-usage state preferences in order to determine how such EGMs should operate with respect to their power-usage states may be configured to retrieve user-specified power-usage state preference information in a seamless manner by wirelessly communicating with a device carried by a user, e.g., a smartphone or a smartwatch. For example, such an EGM may incorporate wireless communications interfaces such as radio-frequency identification (RFID) readers, near-field communications (NFC) receivers, Bluetooth transceivers, or WiFi transceivers that the EGM may use to scan for user-carried devices that may be nearby. When such a nearby device is detected, the EGM may, in some instances, initiate communications with the nearby device without requiring any deliberate act by the user of the device. Once such communications are established, the EGM may then request information from the device as to any user-specified power-usage state preference information that may be associated with the user of the device. In some implementations, the CPMS or a similar system may store such preferences in association with identifier information regarding the device, and the EGM may communicate with the device to obtain the identifier information and then query the CPMS for the user-specified power-usage state preference information that is associated with the identifier information that it obtains from the devices. The identifier information may, for example, be a unique identifier for the device, an identifier identifying a particular player tracking account that is associated with the device, an identifier such as a media access control (MAC) address, an NFC code, and RFID code, etc. The CPMS may then look up the user-specified power-usage state preference information associated with the provided identifier information and transmit information regarding the user-specified power-usage state preference information for that identifier information back to the EGM, which may then take steps to implement the preferred power-usage state for the user with which the user-specified power-usage state preference information is associated.

In some implementations, a vision-based system incorporated into such an EGM may be used for a similar purpose, e.g., to retrieve user-specified power-usage state preference information regarding a particular user. In such implementations, a digital camera or other vision-type or imaging sensor (see imaging sensor 245 in FIG. 2A) may be caused to scan an area in front of an EGM and obtain video or still image footage of the area. Processors of the EGM (or processors remote therefrom) may process the obtained image or video data using one or more image or video analysis algorithms for detecting faces of people captured in the video or still image footage. Such faces may then be matched, e.g., through use of a facial matching algorithm, against facial information that may be stored in, for example, a player tracking system or other system suitable for tracking players/users of EGMs. For example, the EGM may send image data, or information extracted from the image information, to the CPMS for use in image-based facial recognition algorithms. Upon finding a matching user using such facial recognition techniques, such a system may then request that user-specified power-usage state preference information associated with the matching user be provided to the EGM with the vision-based system. The EGM may, on receipt of such information, adjust its power-usage state according to the user-specified power-usage state preference information that is provided, as discussed earlier herein.

In some implementations, EGMs that may incorporate the ability for users to select one of multiple user-selectable power-usage states may be configured to receive instructions as to which power-usage state to operate in from another device, such as the user's smartphone. As discussed above, this may be a “passive” interaction in which the user does not need to take any active steps (aside from being in proximity to the EGM and carrying a device that the EGM can communicate with). However, in some implementations, such interactions may be the result of more deliberate actions by the user. For example, in some instances, the device carried by the user may include software for presenting a GUI in which the user can actively select between different power-usage states that are available for an EGM that they are in proximity to or using. In such implementations, such applications may provide power-usage state instructions to the EGM, e.g., to enter a particular power-usage state, that do not override the stored user-specified power-usage state preference information that may be associated with that user. In such instances, the “default” user-specified power-usage state preference information may remain unchanged and be applied when the user transitions to playing on another EGM, but the EGM that the user is using when they make such a selection may enter whatever power-usage state was selected by the user, regardless of whether it conflicts with the user-specified power-usage state preference information that may have been provided to the EGM earlier. This allows a user to establish default user-specified power-usage state preference information but then override such information for a particular EGM, e.g., that they are using or near to, without changing the user-specified power-usage state preference information going forward. This may allow a user to, for example, increase the power-usage state for a particular EGM without altering their preferred overall power-usage strategy to be applied by default to EGMs.

EGMs that are configured to automatically retrieve user power-usage preferences from a centralized server or system and then modify or adjust their power-usage states in order to align with the user's power-usage preferences may allow users to tailor their experiences on EGMs in a way that seamlessly allows such users to game in a more ecologically responsible manner (although typically at the cost of a less flamboyant gaming experience on such EGMs, e.g., using lower-quality graphics, low-intensity lighting, etc.).

The CPMS and/or EGMs that may allow for or facilitate user control of the power-usage state may also, in some cases, be configured to provide one or more benefits to a user based on the user's selections with regard to the power-usage state of the EGM. The database that stores information regarding the various power-level settings may, for example, also store user benefit information that may define one or more benefits that may be provided to a user in association with a user's selection of a power-usage state associated with a power-level setting on an EGM.

For example, an EGM that has user-selectable power-usage states may, depending on the power-usage state that a user selects, provide the user with a particular benefit to reward users that select power-usage states that lower the amount of power used by the EGM. Such benefits may, for example, include promotional credits for use in playing games on the EGM (or another EGM), in-game enhancements, e.g., a multiplier that the user may elect to apply to an award earned from achieving a winning outcome on the EGM, coupons or vouchers that may be redeemed with various vendors, e.g., a voucher for a free drink from a bar at the casino where the EGM is located, loyalty program points that may be awarded to the player in association with the player tracking account, etc. In some instances, such benefits may only be provided by the EGM to the user after the user has engaged in game play on the EGM for a predetermined period of time or for a given number of game plays with the EGM power-usage state set to the level associated with the benefit(s). For example, the EGM may be configured to provide X free game plays, e.g., one free game play, to the player for every Y paid game plays, e.g., 20 paid game plays, the user engages in on the EGM after causing the EGM to enter into a particular power-usage state, e.g., a low power-usage state (either through direct selection of that power-usage state or through automatic selection of that power-usage state according to pre-established power-usage state preferences of the user that are automatically retrieved by the EGM and then implemented by the EGM).

In some implementations, the power-usage state conditions that a user may satisfy in order to obtain such a benefit may be evaluated with respect to the user's actions over a prolonged period of time. For example, the CPMS may evaluate a user's actual behavior with respect to power-usage state management to determine if the user, for example, played on EGMs a predetermined number of times within a given time period (e.g., a week, a month, a year) using one or more user-specified power-usage state preferences that result in lower EGM power consumption as opposed to other user-specified power-usage state preferences, maintained one or more user-specified power-usage state preferences that result in lower EGM power consumption for a predetermined period of time without changing to a user-specified power-usage state preference that resulted EGM power consumption to increase beyond at least a threshold amount, and so forth. If such conditions are met, then the CPMS may provide the associated benefit to the user.

In alternative or additional implementations, the CPMS may manage the provisioning of benefits to the user based on the user's use of an EGM while the EGM is operating in a user-selected power-usage state. For example, such an EGM may, in conjunction with entering a user-selected power-usage state (either in response to a user selection of a power-usage state via a GUI of the EGM or to the EGM automatically entering into a user-selected power-usage state after receiving information regarding the user's preferred power-usage settings), send a message, e.g., a power-usage state status message, to the CPMS that includes information that allows the CPMS to identify the user and the power-usage state that the user has caused the EGM to operate in. In some instances, the EGM may periodically send, e.g., every minute or every five minutes, a further power-usage state status (or status update) message to the CPMS that provides updated information on the user's activity and/or the power-usage state of the EGM. Such messages may, for example, include information indicating how long the EGM has been operating in the power-state selected by the user, how many game plays the user has engaged in within a given time period (e.g., since the user first started using the EGM with the EGM operating in the selected power-usage state or since the last power-usage state status update message was sent by the EGM). Such power-usage state status update messages may also be sent by such an EGM on a non-temporal basis, e.g., responsive to certain conditions being satisfied that may not necessarily be time-dependent, e.g., the EGM may send a power-usage state status update message every time the user completes a predetermined number of game plays, e.g., every twenty game plays. The CPMS may then, based at least in part on the information contained in the power-usage state status update messages, determine whether one or more conditions governing the award of a benefit are satisfied and, if the determination is made that such a condition or conditions are met, cause the benefit to be awarded to the user. For example, the CPMS may send an award message to the EGM that is configured to cause the EGM to provide a benefit, e.g., a free play of the game provided by the EGM, to the user.

As discussed above, various types of user-initiated actions regarding user-selectable power-usage states on EGMs (or default power-usage states with regard to player-tracking accounts) may be recognized by the CPMS as satisfying conditions that lead the CPMS to provide the user with a benefit. Examples of some such user-initiated actions that may be recognized by EGMs and/or the CPMS as satisfying such conditions are listed below, although this list is not exclusive.

Potential user actions that EGM/CPMS may cause benefit to be provided to user . . .
a) Selection of a particular power-usage state to be used by the EGM.
b) Being engaged in play on the EGM with an eligible user-selected power-usage state in effect for X minutes, e.g., 10, 15, 20, 30, 45, 60 minutes or longer.
c) Being engaged in play on the EGM with an eligible user-selected power-usage state in effect for X minutes (repeatable), e.g., every 10, 15, 20, 30, 45, 60 minutes or longer.
d) Engaging in X game plays on the EGM with an eligible user-selected power-usage state in effect, e.g., 5, 10, 15, 20, 25, 30, 35, 40, 45, 50 or more game plays.

e) Engaging in X game plays on the EGM with an eligible user-selected power-usage state in effect (repeatable), e.g., 5, 10, 15, 20, 25, 30, 35, 40, 45, 50 or more game plays.

f) Designating an eligible power-usage state as a default user-selected power-usage state associated with a user player tracking account.

As also alluded to above, the benefits that the CPMS may cause to be provided to the user in response to such conditions being met may take a variety of forms, including, but not limited to, the example benefits listed below.

Potential user benefits that may be caused to be awarded to user satisfying user-selectable power-usage conditions . . .
a) User is provided with X free plays of a game on an EGM, e.g., 1, 2, 3, 4, 5, 10, 15, 20, 25, 30, game plays.
b) User is provided with a multiplier that causes the next X outcomes of a game played on an EGM (or EGMs) that result in the user winning an amount to be multiplied by Y, where X may be 1, 2, 3, 4, 5, 6, 7, 8, 9, 10, 15, 20, 25, 30, etc. winning amount outcomes and Y may be 1, 2, 3, 4, 5, 10, etc.
c) User is provided with X user-selectable wild symbols, each user-selectable wild-symbol being exchangeable by the user to replace a symbol in a game outcome with a wild symbol that may serve as any symbol obtainable in that game outcome, where X may be 1, 2, 3, 4, 5, 6, 7, 8, 9, 10, 15, 20, 25, 30, etc.
d) User is provided with an amount of loyalty points, e.g., points that are associated with a particular user and that are used to determine the user's status or level in a loyalty program managed by a casino or other entity. For example, the user may be provided with X loyalty program points, where X may be 1, 2, 3, 4, 5, 6, 7, 8, 9, 10, 15, 20, 25, 30, etc. In some instances, the user may be provided a number of loyalty program points (or a single loyalty program point) each time they engage in a game play on an EGM in which the user has selected an eligible power-usage setting.
e) The rate at which the user earns player loyalty points is multiplied by a multiplier for a given period of time, e.g., a fixed time or the time during which the user plays on an EGM using the eligible power-usage setting. The multiplier may, in some cases, have a value that is tied to the level of power usage associated with the selected power-usage setting, e.g., a higher multiplier for selected power-usage settings that result in greater power savings and a lower multiplier for selected power-usage settings that result in lower power savings.
f) User is provided with an enhanced status in a loyalty program. For example, loyalty programs may assign a status to an account holder depending on that account holder's activity. For example, loyalty program points may be awarded to account holders based on various actions undertaken by such individuals, e.g., based on playing games on EGMs, staying in an affiliated casino, etc., and the total balance of loyalty program points associated with a particular account holder may be used to determine what “level” or “status” the account holder is within the loyalty program-account holders with higher-ranked statuses or levels may be afforded certain perks or additional benefits over account holders with lower-ranked statuses or levels.
g) User is provided with a special status, e.g., in a loyalty program or external to a loyalty program, that identifies them as having taken environmentally responsible actions. For example, such a special status may permit the user to choose a graphical effect (e.g., a green glow) that may be applied to a graphical element representing that user, an embellishment, a badge that may be displayed in association with that user, a limited-availability avatar that the user may use to represent themselves in graphical user interfaces, or another graphical indicator that may be displayed to others in association with that user, e.g., in a social chat application, on leaderboards, in multi-player games in which each player is represented by a graphical avatar, etc. Such embellishments, badges, or other graphical indicators may, for example, be designed to convey that the user is environmentally conscious or has contributed in some way to protecting the environment, e.g., depicting a leaf, an animal, the planet earth, plants, flowers, etc. In some instances, EGMs may be configured to enter into a particular state or mode when such an EGM determines, e.g., through receiving a message from the CPMS or some other system, that a user using the EGM has such a status. For example, such an EGM may cause overhead signage and/or external lighting of the EGM to change to a particular color scheme, e.g., having greens and/or blues, to indicate that the user has opted to cause EGMs to use more environmentally friendly power-usage states.
h) User is provided with a coupon or voucher that is redeemable for food (snacks, appetizers, dinners, lunches, breakfasts, desserts, etc.), drink (cocktail, beer, ale, wine, non-alcoholic beverage, coffee, etc.), lodging, entertainment (tickets to a concert, musical, play, acrobatic show, etc.), experiential events (tours, activities, etc.), souvenirs, clothing, jewelry, etc.

As discussed above, power-level settings retrieved by the CPMS may, in some instances, include component information. Such component information may, for example, designate particular components or subsystems of an EGM that are to have their power-usage states modified in accord with the associated power-level setting. For example, a power-level setting may include information that indicates that the exterior lighting systems of an EGM are to be reduced in intensity to 50% of their maximum value. An EGM that is sent a power-level setting message based on such information may, on receipt of such a message (or, if applicable, at a time and date specified by such a message or when the relevant power-level settings are caused by the EGM to be acted upon) cause the exterior lighting systems of the EGM to be reduced in intensity to 50% of their maximum intensity, but may otherwise not modify the power-usage states of other systems of the EGM (unless, of course, the power-level setting message also includes information indicating that such other systems of the EGM should also have their power-usage states modified or unless other power-level setting messages are received that may individually cause another system or systems of the EGM to change power-usage state).

Such component information may, in some instances, take the form of specific components or of more generic references to such components. For example, each EGM may store a hierarchy or multi-level categorization of each component and/or sub-system of the EGM that allows components and sub-systems to be identified at varying levels of granularity, e.g., through identifying component and sub-systems via different levels of the hierarchy. The EGM may be further configured to identify components and sub-systems that are in a specific category or categories or sub-category or subcategories that are identified by a power-level setting message as being the target components or sub-systems that are to have their power-usage state modified based on the information contained in the power-level setting message and to then, when such a power-usage state is to be implemented, cause the identified components or sub-systems to adjust their power-usage states accordingly. By way of illustration, the table below provides an example of one hierarchical or multi-level categorization of components and sub-systems of an EGM, although it will be recognized that more or fewer levels of categorization may be used, and that fewer or more components or sub-systems may be listed. It will also be understood that there may be an additional category (not shown below) that may represent the entire EGM. In some EGMs that support such component-and sub-system-level modification of power usage states, a power-level setting message that does not specify components or sub-systems, or categories or sub-categories of such components and/or sub-systems, that are to have their power-usage states adjusted based on the information in such a power-level setting message may be configured to treat such a “generic” power-level setting message as specifying a power-usage state for the entire EGM.

| General | | |
|---|---|---|
| Category | Sub-Category | Component or Sub-System |
| Lighting | Exterior Lighting | Exterior LED strips |
| | | Electroluminescent panels |
| | Display Lighting | Main display panel backlight |
| | | Secondary display panel backlight |
| | | Auxiliary display panel(s) backlights |
| Audio | Speakers | Speakers |
| Displays | Game displays | Main display panel |
| | | Secondary display panel |
| | Auxiliary display(s) | Auxiliary display panel(s) |
| Processors | CPU | CPU |
| | GPU | Main display GPU |
| | | Secondary display GPU |
| Mechanisms | Bill Acceptor | Bill Acceptor |
| | Movable Elements | Movable Elements |
| | Haptics | Haptics |
| | Printers | Ticket Dispenser |
| | | Voucher Dispenser |

Each EGM that is configured to perform such component-or sub-system-level adjustment of power-usage states may, when caused to put a component-or sub-system-level adjustment of power-usage state into effect, cause the components or sub-systems that are designated or identified for such power-usage state adjustment to change their power-usage states by altering one or more operational parameters associated with those components and/or sub-systems, such as operating current, operating voltage, clock speed, resolution (if applicable), etc. However, components and/or sub-systems that are not included in such designated or identified components and/or sub-systems may have their power-usage states left unchanged, thereby allowing for a very granular level of power-usage adjustment of EGMs to be performed, if desired.

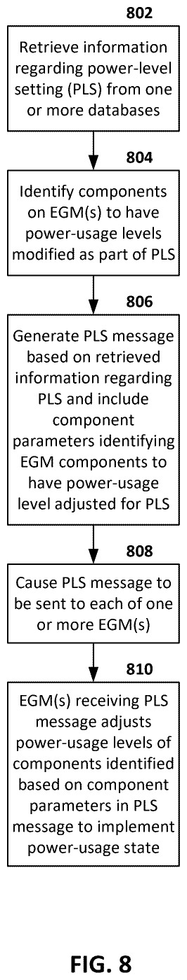

FIG. 8 depicts an example technique for implementing component-level power-usage settings for an EGM. In block 802, the CPMS may retrieve information regarding a power-level setting from one or more databases. In block 804, the CPMS may identify components or sub-systems of one or more EGMs that are to have power-usage levels modified based on the power-level setting. In block 806, the CPMS may generate a power-level setting message that includes component parameters that may, on receipt of the power-level setting message by an EGM, cause the EGM to configure itself to offer the power-usage state defined by the power-level settings by adjusting the power-usage levels of the components of the EGM identified by the component parameters in the power-level setting message. In block 808, the CPMS may cause the generated power-level setting message(s) to be sent to the one or more EGMs, while in block 810, the EGMs that receive the power-level setting messages from block 808 may, in response at least in part to receipt of such power-level setting messages, configure themselves to operate the components or sub-systems identified by the component parameters in the power-usage states defined by the power-level setting.

As noted earlier, power-level messages contain information that defines a power-usage state for an EGM (or other piece of equipment, like signage). The device, e.g., an EGM, that receives such a power-level message may then reconfigure itself to implement a power-usage state that aligns with the specific power-level setting on which that power-level message was based. However, the specific timing of when the device does so may vary. For example, as discussed earlier, some power-level setting messages may be configured to cause a receiving device to enter the associated power-usage state responsive to receipt of that power-level setting message (in which case, the EGM, upon receipt of such a power-level setting message, may transition into the associated power-usage state relatively instantaneously or immediately). In other instances, a power-level setting message may include schedule parameters that define one or more dates and times when the power-usage state associated with that power-level setting message is to be implemented by the receiving device-in such cases, the receiving device, despite having received the information that defines a power-usage state by way of the power-level setting message, would not necessarily immediately enter that power-usage state and would instead wait until the scheduled date(s) and time(s).

It will be apparent from the above discussion that an EGM or other device that receives power-level setting messages from the CPMS may store information regarding multiple different power-usage states associated with multiple different power-level setting messages in memory and then, as needed, modify its power-usage state according to such stored information on an as-needed basis.

Thus, an EGM or other device that receives such power-level setting messages may, in some instances, preconfigure itself to be ready to enter into one of several power-usage states, and then to enter a selected one of those power-usage state responsive to certain stimuli, such as certain conditions being met. Such conditions, as has been discussed above, may include the current time and date aligning with a date and time specified in schedule parameters that may be associated with a particular power-level setting message or the selection of a particular power-usage state by a user of the EGM via a user-selectable control in a GUI of the EGM. However, there may also be other events which, on occurrence, may cause the EGM to enter one of the various power-usage states that the EGM has preconfigured itself with.

For example, some EGMs may have sensors, such as proximity sensors (see proximity sensor 241 in FIG. 2A), motion sensors (see motion sensor 243 in FIG. 2A), or other types of sensors, that may be used by the EGM to detect when there are potentially one or more people in the vicinity of the EGM (or at least, when data from the sensor(s) suggests that such may be the case). In such an EGM, the EGM may, for example, be configured (e.g., by parameters set forth in the power-level settings message or via other parameters) to transition to a given power-usage state responsive to such sensors either detecting more than a predetermined number, e.g., one, two, three, etc., of potential people within a predetermined distance of the EGM or detecting less than a predetermined number of potential people within the predetermined distance of the EGM.

For example, in some implementations, a first power-level settings message received by an EGM may include parameters that cause the EGM to preconfigure power-usage settings that, when implemented by the EGM, cause the EGM to enter a first power-usage state that is arrived at by, at least in part, turning off the displays of the EGM (thereby presenting black screens). Similarly, the EGM may also receive a second power-level settings message that may include parameters that cause the EGM to preconfigure power-usage settings that, when implemented by the EGM, cause the EGM to enter a second power-usage state that is arrived at, at least in part, by turning on the displays of the EGM and displaying content on the displays. The first power-level settings message may also include parameters that cause the EGM to enter the first power-usage state responsive to the sensor(s) of the EGM detecting that there are no potential people detected within X feet, e.g., 20 feet, of the EGM and to enter the second power-usage state responsive to the sensor(s) of the EGM detecting one or more potential people within X feet of the EGM. Such an arrangement may allow for EGMs to engage in more aggressive power-conservation strategies that may be less than desirable in some contexts. For example, if there are no people near an EGM, there may be little reason for power to be expended in by the EGM to display graphics on the displays of the EGM since there will be no potential spectators nearby. While EGMs are often located in venues where there is nearly always activity, there may be portions of such venues that may see significantly reduced traffic during the early morning hours, for example, and it may thus be desirable to configure the EGMs in such areas to adopt such a more-aggressive power-conservation strategy. However, if someone, e.g., a potential player, does wander into such an area while the EGMs are implementing the first power-usage state, such a person may mistakenly believe that these EGMs are malfunctioning or otherwise non-operable due to their black screens. The person may thus move on and forego attempting to play a game on such an EGM, thereby potentially resulting in a loss of revenue from the person.

However, if such an EGM is configured to detect the presence of a potential player, e.g., a person, in the vicinity of the EGM and to then, in response to such a detection event, transition itself from the first power-usage state to the second power-usage state, thereby causing the displays of the EGM to re-activate and display graphics, the potential player may realize that the EGMs in question were not non-operative and that they are available for use, at which point the potential player may opt to engage in game play on one of the EGMs.

In some such implementations, the first power-usage state may be one in which the power provided to, for example, decorative lighting modules (edge strip lighting, for example), CPUs/GPUs, speakers, screen backlighting, etc., may be reduced to a lower level as compared to the amount of power delivered to such devices in the second power-usage state, resulting in correspondingly lower levels of illumination, CPU/GPU clock speed, audio volume, screen brightness, etc. It is estimated that such intelligent management of gaming machine device power state may reduce overall power consumption by gaming machines configured to implement such practices by approximately 50% when operating in the first power-usage state as compared to operating in the second power-usage state.

In some implementations, an EGM with a power-management system having proximity sensors may be configured to operate in a different manner, with the EGM reverting to operating in the first power-usage state (a lower power-usage state) when one or more people are detected by the one or more proximity sensors as being within a predetermined distance of the EGM (or within a predetermined area near the EGM) but transitioning to, or remaining in, the second power-usage state (a higher power-usage state) when nobody is detected within the predetermined distance of (or within the predetermined area near) the EGM. Such a configuration may result in the EGM being more easily seen or noticed from a distance due to its peripherals operating with higher power (brighter illumination effects, louder audio, etc.), which may be more effective at drawing potential users towards the EGM. Once the potential users are near the EGM, the EGM may switch to a lower power-usage state to conserve energy. In some such implementations, the EGM may be configured to remain in a lower power-usage state unless one or more people are detected by the proximity sensors as being within one or more predetermined areas around the EGM, e.g., areas within line-of-sight of the EGM. On detecting the presence of one or more people within such areas, the EGM may determine if any such people are within a first distance of the EGM or are more than the first distance away from the EGM. If within the first distance of the EGM, then the EGM may cause its power-usage state to remain unchanged or at a lower power-usage state. If more than the first distance away from the EGM, then the EGM may cause its power usage-state to transition to a higher power-usage state in order to generate a more noticeable audio and/or visual display and potentially attract the people that are more than the first distance away from the EGM to be closer to the EGM.

It will be understood that the various triggering criteria that may be used to cause an EGM to enter a particular power-usage state may be combined as desired. For example, motion-or proximity-sensor based transitions from one power-usage state to another for an EGM may be configured to only occur during certain time windows on certain dates, e.g., only on weekdays during the hours of 1 AM to 7 AM, which may be times that historically see reduced foot traffic in the vicinity of the EGM in question. During other dates and times, such an EGM may be caused, in response to other power-level setting messages, to adopt a different power-conservation strategy.

EGMs may also be preconfigured to prioritize some power-usage state triggering conditions over others. For example, if a user begins to use an EGM that is in a particular power-usage state, e.g., a power-usage state in which certain features, such as exterior lighting, are deactivated or operated at a lower power-level during certain hours, the EGM may, in response to detecting that the user is interacting with it, automatically transition to a power-usage state in which such features may be transitioned to operate at a higher power-usage state, thereby overriding the scheduled power-usage state. Similarly, if the EGM then determines that the user in question has selected a different power-usage state, e.g., as discussed earlier, the EGM may then transition to the user-selected power-usage state, thereby overriding the default “in-use” power-usage state that the EGM had transitioned into in response to the determination by the EGM that the user was interacting with it. Such EGMs may also be preconfigured to revert to lower-priority power-usage states upon the removal of a stimulus or condition that caused such an EGM to be in a higher-priority power-usage state. For example, if the user then logs out of the EGM, e.g., as may be indicated by a user concluding play of a game on the EGM and cashing out, the EGM may then revert to operating in the power-usage state in which the exterior lighting is deactivated or to a power usage state that would otherwise be in effect at that time, e.g., due to a preexisting schedule.

It will be appreciated that while the concepts discussed above are discussed in the framework of the CPMS, many of the concepts discussed above may also be implemented in EGMs directly, e.g., without the use of the CPMS. For example, an EGM may be preconfigured with particular power management profiles and with rules, e.g., schedule rules, user interaction rules, etc., that may cause the EGM to implement one or more of the power management profiles in response to various stimuli, as discussed above. The use of the CPMS, however, may greatly facilitate implementing a coherent power-management strategy across a large fleet of EGMs. In some instances, the EGMs and CPMS may be viewed as representing a distributed processing implementation of a power-management architecture. It will also be understood that various functions of the CPMS and/or EGMs discussed above may also be distributed amongst other types of systems. For example, user-specific power level selectivity information may be stored in, and retrievable from, a player tracking system or may be stored locally on a user's smartphone or other device.

In recognition of the possibility of such distributed processing arrangements, the term “collectively” may be used herein with reference to memory devices and/or processors or various other items to indicate that the referenced collection of items has the characteristics or provides the functionalities that are associated with that collection. For example, if a server and a client device such as an EGM collectively store instructions for causing A, B, and C to occur, this encompasses at least the following scenarios:
a) The server stores instructions for causing A, B, and C to occur, but the client device stores no instructions that cause A, B, and C to occur.
b) The client device stores instructions for causing A, B, and C to occur, but the server stores no instructions that cause A, B, and C to occur.
c) The server stores instructions for causing a proper subset of A, B, and C to occur, e.g., A and B but not C, and the client device stores instructions that cause a different proper subset of A, B, and C to occur, e.g., C but not A and B, where instructions for causing each of A, B, and C to occur are respectively stored on either or both the client device and the server.
d) The server stores instructions for causing a subset of A, B, and C to occur, e.g., A and B but not C, and the client device stores instructions that cause a different subset of A, B, and C to occur, e.g., B and C but not A, where instructions for causing each of A, B, and C to occur are respectively stored on either or both the client device and the server.
e) The server stores instructions for causing A and a portion of B to occur, and the client device stores instructions that cause C and the remaining portion of B to occur.

In all of the above scenarios, between the server and the client device, there are, collectively, instructions that are stored for causing A, B, and C to occur, i.e., such instructions are stored on one or both devices and it will be recognized that using the term “collectively,” e.g., the server and the client device, collectively, store instructions for causing A, B, and C to occur, encompasses all of the above scenarios as well as additional, similar scenarios.

Similarly, a collection of processors, e.g., a first set of one or more processors and a second set of one or more processors, may be caused, collectively, to perform one or more actions, e.g., actions A, B, and C. As with the previous example, various permutations fall within the scope of such “collective” language:
a) The first set of one or more processors may be caused to perform each of A, B, and C, and the second set of one or more processors may not perform any of A, B, or C.
b) The second set of one or more processors may be caused to perform each of A, B, and C, and the first set of one or more processors may not perform any of A, B, or C.
c) The first set of one or more processors may be caused to perform a proper subset of A, B, and C, and the second set of one or more processors may be caused to perform a different proper subset of A, B, and C to be performed such that between the two sets of processors, all of A, B, and C are caused to be performed.
d) The first set of one or more processors may be caused to perform A and a portion of B, and the second set of one or more processors may be caused to perform C and the remainder of B.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items-it will be understood that a set or a subset can encompass only one member or multiple members (unless the context indicates otherwise).

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure.

What is claimed is:

1. A system comprising:
one or more processors;
one or more memory devices; and
one or more communications interfaces, wherein the one or more memory devices store computer-executable instructions which, when executed by the one or more processors, cause the one or more processors to:
cause information regarding a first power-level setting to be retrieved from one or more databases,
cause a first power-level setting message based on the information regarding the first power-level setting to be generated, and
cause the first power-level setting message to be sent to each electronic gaming machine in a first set of one or more electronic gaming machines via the one or more communications interfaces, wherein the first power-level setting message caused to be sent to each electronic gaming machine in the first set of one or more electronic gaming machines is configured so as to cause that electronic gaming machine to enter a first power-usage state based, at least in part, on the first power-level setting.

2. The system of claim 1, wherein:
the information regarding the first power-level setting includes schedule information, and
the computer-executable instructions, when executed by the one or more processors, further cause the one or more processors to cause the first power-level setting message to be sent to each electronic gaming machine in the first set of one or more electronic gaming machines at a time defined by the schedule information.

3. The system of claim 1, wherein:
the information regarding the first power-level setting includes schedule information,
the first power-level setting message includes schedule parameters based on the schedule information, and
the first power-level setting message caused to be sent to each electronic gaming machine in the first set of one or more electronic gaming machines is further configured so as to cause that electronic gaming machine to enter the first power-usage state at a time defined by the schedule parameters.

4. The system of claim 1, wherein:
the information regarding the first power-level setting includes component information,
the first power-level setting message includes component parameters based on the component information, and
the first power-level setting message caused to be sent to each electronic gaming machine in the first set of one or more electronic gaming machines is further configured so as to cause that electronic gaming machine to select one or more gaming machine components of that electronic gaming machine based on the component parameters and to cause the selected one or more gaming machine components to change power states in order to cause the electronic gaming machine to enter the first power-usage state.

5. The system of claim 1, wherein:
the one or more databases store information regarding multiple power-level settings,
the multiple power-level settings including the first power-level setting and a second power-level setting, and
the one or more memory devices further store computer-executable instructions which, when executed by the one or more processors, further cause the one or more processors to:
cause information regarding the second power-level setting to be retrieved from the one or more databases,
cause a second power-level setting message based on the information regarding the second power-level setting to be generated, and
cause the second power-level setting message to be sent to each electronic gaming machine in a second set of one or more electronic gaming machines via the one or more communications interfaces, wherein the second power-level setting message caused to be sent to each electronic gaming machine in the second set of one or more electronic gaming machines is configured so as to cause that electronic gaming machine to enter a second power-usage state based, at least in part, on the second power-level setting, wherein:
the first set of one or more electronic gaming machines and the second set of one or more electronic gaming machines have at least one electronic gaming machine in common, and
the first power usage state and the second power usage state are different from one another.

6. The system of claim 1, wherein:
the information regarding the first power-level setting includes user-selectivity information,
the first power-level setting message includes user-selectivity parameters based on the user-selectivity information, and
the first power-level setting message caused to be sent to each electronic gaming machine in the first set of one or more electronic gaming machines is further configured so as to cause that electronic gaming machine to enter the first power-usage state in response to receiving a message indicative of a selection of the power-usage state associated with the first power-level setting by a first user of the electronic gaming machine.

7. The system of claim 6, wherein:
the information regarding the first power-level setting includes user benefit information, and
the one or more memory devices further store computer-executable instructions which, when executed by the one or more processors, further cause the one or more processors to:
receive a first user selection message from one of the electronic gaming machines in the first set of electronic gaming machines indicating that that electronic gaming machine has entered the first power-usage state in response to receiving the message indicative of the selection of the power conservation state associated with the first power-level setting by the first user, and
cause a first benefit to be provided to the first player responsive, at least in part, to receipt of the first user selection message.

8. The system of claim 7, wherein the first benefit is a benefit that affects play of a game on the electronic gaming machine from which the first user selection message was received.

9. The system of claim 7, wherein the first benefit is an amount of loyalty program points provided to a loyalty program account associated with the first user.

10. The system of claim 7, wherein the first benefit is a graphical indicator that is displayed in association with information associated with a user account belonging to the first user.

11. The system of claim 10, wherein the graphical indicator is a badge, avatar, or graphical effect.

12. An electronic gaming machine comprising:
a gaming machine cabinet;
one or more peripheral devices;
one or more processors;
one or more memory devices; and
one or more displays supported by the gaming machine cabinet, wherein the one or more memory devices store computer-executable instructions which, when executed by the one or more processors, cause the one or more processors to:
obtain information regarding a first power-level setting,
cause at least some of the one or more peripheral devices to enter a first power-usage state defined by the information regarding the first power-level setting,
obtain information regarding a second power-level setting associated with a user of the electronic gaming machine, and
cause at least some of the one or more peripheral devices to enter a second power-usage state defined by the information regarding the second power-level setting, wherein the electronic gaming machine uses a lower amount of power in the second power-usage state than in the first power-usage state.

13. The electronic gaming machine of claim 12, wherein the one or more memory devices store further computer-executable instructions which, when executed by the one or more processors, further cause the one or more processors to:
obtain information identifying the user of the electronic gaming machine,
transmit a request to a remote device for the information regarding the second power-level setting associated with the user of the electronic gaming machine, the request including the information identifying the user of the electronic gaming machine, and
obtain the information regarding the second power-level setting associated with the user of the electronic gaming machine by receiving a message from the remote device having the information regarding the second power-level setting associated with the user of the electronic gaming machine.

14. The electronic gaming machine of claim 13, further comprising one or more imaging sensors, wherein the one or more memory devices store further computer-executable instructions which, when executed by the one or more processors, further cause the one or more processors to:
cause the one or more imaging sensors to obtain image information regarding the user of the electronic gaming machine, and
transmit the image information, or information extracted from the image information, to the remote device as the information identifying the user of the electronic gaming machine.

15. The electronic gaming machine of claim 13, wherein the one or more memory devices store further computer-executable instructions which, when executed by the one or more processors, further cause the one or more processors to:
obtain information from the user regarding a player tracking account associated with the user, and
transmit information identifying the player tracking account of the user to the remote device as the information identifying the user of the electronic gaming machine.

16. The electronic gaming machine of claim 12, wherein the one or more memory devices store further computer-executable instructions which, when executed by the one or more processors, further cause the one or more processors to:
cause a graphical user interface to be provided on the one or more displays, the graphical user interface including one or more user-selectable controls for enabling selection of the second power-level setting by the user, and
cause the at least some of the one or more peripheral devices to enter the second power-usage state defined by the information regarding the second power-level setting responsive to receipt of an input signal indicating that the one or more user-selectable controls for enabling the selection of the second power-level setting by the user was or were selected by the user.

17. The electronic gaming machine of claim 16, wherein the one or more memory devices store further computer-executable instructions which, when executed by the one or more processors, further cause the one or more processors to cause a benefit to be provided to the user in response to the user causing the at least some of the one or more peripheral devices to be in the second power-usage state for at least a first period of time or for a first number of game plays.

18. The electronic gaming machine of claim 17, wherein the benefit affects play of a game presented on the one or more displays of the electronic gaming machine.

19. The electronic gaming machine of claim 17, wherein the benefit is an amount of loyalty program points provided to a loyalty program account associated with the user or a graphical indicator that is displayed in association with information associated with a user account belonging to the user.

20. The electronic gaming machine of claim 12, further comprising a sensor, wherein:
the sensor is a proximity sensor, an imaging sensor, or a motion sensor; and
the one or more memory devices store additional computer-executable instructions which, when executed by the one or more processors, further cause the one or more processors to:
enter a power-usage state in which the electronic gaming machine uses a lower amount of power than in the first power-usage state when data from the sensor suggests that there are no people within a first region proximate the electronic gaming machine, and
enter the first power-usage state when the data from the sensor suggests that one or more people are within the first region proximate the electronic gaming machine.
